(19) United States
(12) Patent Application Publication
(10) Pub. No.: US 2007/0258109 A1
(43) Pub. Date: Nov. 8, 2007

(54) Image forming device, image forming method, and computer readable storage medium storing image forming program

(75) Inventor: Eiji Sasaki, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/511,370

(22) Filed: Aug. 29, 2006

(30) Foreign Application Priority Data
May 2, 2006 (JP) 2006-128152

(51) Int. Cl. G06K 15/00

(52) U.S. Cl. 358/1.16

(57) ABSTRACT

A printer receives printing data and sets the area of an external memory as the area that is usable for processing the received printing data when it is judged that memory shortage status has occurred concerning a shortage of vacant areas in the internal memory built into the printer and when it is detected that the external memory is connected to an external memory interface that can be connected to or disconnected from the particular printer while the printer is powered.

### CROSS-REFERENCE TO RELATED APPLICATION

This application is based on Japanese Patent Application No. 2006-128152 filed on May 2, 2006, the contents of which are incorporated herein by reference.

### BACKGROUND OF THE INVENTION

1. Field of the Invention

The invention relates to an image forming device, an image forming method, and a computer readable storage medium storing an image forming program.

2. Description of Related Art

An image forming device such as a printer performs imaging and printing processes in order to print images on a recording medium such as paper, based on printing data received from a device such as a personal computer (“PC”). In doing so, the image forming device performs such imaging and printing processes using an internal memory built into said image forming device.

However, if the amount of printing data received from the PC is very large, the printer's internal memory may not have a sufficient available space, resulting in an error to stop the printing process.

Various technologies have been proposed in order to prevent such a memory insufficiency situation in the image forming device, either by compressing data or improving the efficiency of usage of the memory, but they are not necessarily enough to avoid such a memory insufficiency situation.

Furthermore, technology is available for averting memory shortage by means of reducing the amount of internal memory usage by reducing the resolution of printing output images, which, however, makes it impossible to get high quality output images.

It is also possible to avert the occurrence of memory shortage by increasing the memory capacity or having a large capacity memory device such as a hard disk, but it makes it inevitable for the printing device to be connected to those large capacity memory devices constantly, resulting in a cost increase. Such a cost increase is undesirable for a user who expects such a memory shortage case to occur very infrequently. On the other hand, a method has been proposed to avert memory shortage by means of having the image forming device communicate reciprocally with an external device such as another image forming device, which is connected to the first image forming device via a network, and transferring printing data to said external device. See Unexamined Publication Nos. JP-A-8-123252 and No. JP-A-9-247399.

However, this technology has an inherent problem that said technology is only applicable to a large system where an image forming device is connected in advance to an external device via a network, and that a complex control system is required for the transfer of printing data to the external device.

### OBJECTS AND SUMMARY

It is an object of the present invention to provide an image forming device, an image forming method, and a computer readable storage medium storing an image forming program which are inexpensive, simple, and capable of preventing the memory shortage problem at the image forming device, allowing the intended printing to be continued, which are improved for solving the abovementioned problems.

According to an embodiment of the invention, there is provided an image forming device. The image forming device comprises a receiving unit, a connection unit and a control unit. The receiving unit receives printing data. The connection unit is capable of connecting and disconnecting an external memory to and from the image forming device while the image forming device is powered. The control unit sets at least a portion of the external memory's area as an area usable for processing related to image forming based on the printing data when the external memory is connected to the connection unit.

According to another embodiment of the invention, there is provided an image forming method. The method comprises following the steps: (1) receiving printing data, (2) setting at least a portion of said external memory's area as an area usable for processing related to image forming based on said printing data when the external memory is connected to said connection unit that is capable of connecting and disconnecting an external memory to and from said image forming device while the image forming device is powered.

The objects, features and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the constitution of a printer used as an image forming device according to one embodiment of the invention.

FIG. 2 is a view of an operating panel and an external memory unit.

FIG. 3 is a diagram showing the constitution of a firmware mounted on the printer.

FIG. 4 is a flowchart showing the process sequence on the printer.

FIG. 5 is a flowchart showing the process sequence for solving the memory shortage shown in FIG. 4.

FIG. 6 is a diagram showing various areas of the internal memory.

FIG. 7 is a display example of information notifying a memory shortage status.

FIG. 8 is a display example of information notifying that the external memory is in use.

FIG. 9 is a display example of information notifying that the external memory can be removed.

FIG. 10 is a display example of information notifying an error status in case when the external memory is removed while its virtual memory area is being used.

FIG. 11 is a display example of information notifying an error status in case when printing cannot be continued due to a shortage of available space in the external memory.

### DETAILED DESCRIPTION OF PREFERRED EMBODIMENTS

An embodiment of this invention will be described below with reference to the accompanying drawings.

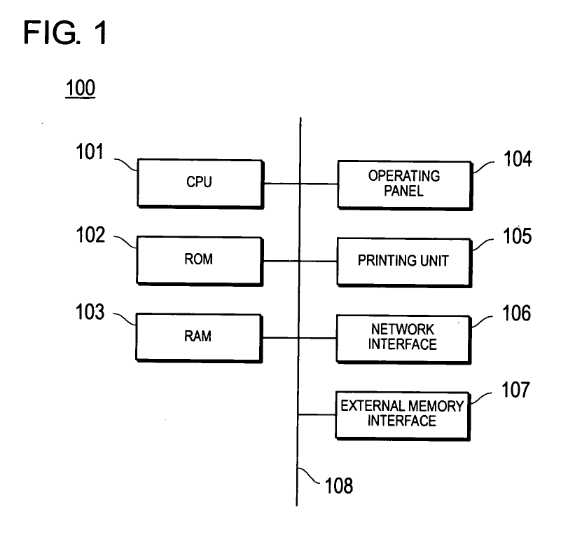

FIG. 1 is a block diagram showing the constitution of a printer used as an image forming device according to the present embodiment.

Printer 100 has a CPU 101, a ROM 102, a RAM 103, an operating panel 104, a printing unit 105, a network interface 106, and an external memory interface 107, all of which are interconnected with each other via a bus 108 for exchanging signals.

The CPU 101 controls various parts indicated above and executes various arithmetic processes according to a program. The ROM 102 stores various programs and data. The RAM 103 stores programs and data temporarily as a working area. The RAM 103 is an internal memory unit built into the printer 100, which is also called the internal memory hereunder.

The operating panel 104 is used for various information displays and for entering various instructions. The printing unit 105 prints images on recording media such as paper using a known image forming process such as an electronic photography type process.

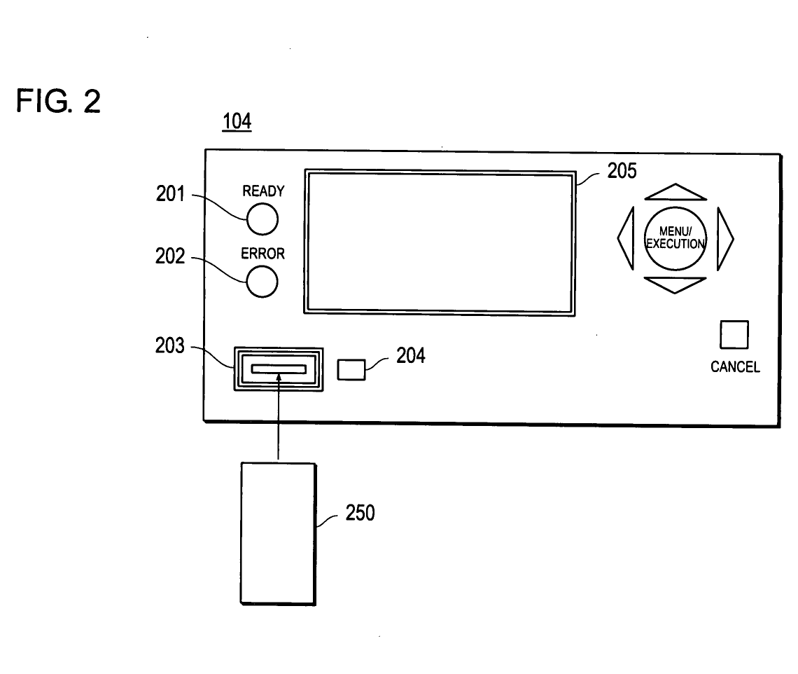

The network interface 106 is an interface for communicating with other devices on the network via the network using standards such as Ethernet®, Token Ring, FDDI, etc. The external memory interface 107 is an interface that can connect or disconnect the external memory 250 (see FIG. 2) to the printer 100 while the printer 100 is being energized. The external memory interface 107 contains the external memory interface connector 203 (see FIG. 2) to which the external memory 250 can be connected.

The external memory interface 107 discussed here is, for example, a USB (Universal Serial Bus) interface, and the external memory 250 is, for example, a USB memory. When the USB memory, which is a USB Mass Storage Class memory device, is connected to the USB interface, the connected USB memory is recognized as a memory device on the host side. The USB memory discussed here is a flash memory that can be used by being connected to a connector that meets the USB standard.

As shown in FIG. 2, the operating panel 104 has a ready lamp 201, an error lamp 202, an external memory interface connector 203, an external memory status indicating lamp 204, and a display panel 205. The ready lamp 201 lights when the printer 100 is ready, and the error lamp 202 lights when an error occurs in the printer 100. The external memory status indicating lamp 204 is an LED (Light Emitting Diode) that displays the status of the external memory 250. The external memory status display lamp 204 turns off when the external memory 250 is not connected; turns on when the external memory 250 is connected and is not used; and flashes (turns on and off intermittently) when the external memory 250 is connected and is used. The external memory 250 can be removed freely if the external memory status indicating lamp 204 is not in a flashing state. The display panel 205 displays not only the status of the printer 100, i.e., the status of the device, but also the countermeasures when an error occurs, the menu for setting up the printer 100, etc. An LCD (Liquid Crystal Display), for example, can be used as the display panel 205. The printer 100 can include components other than those components mentioned above, or can lack some of the components mentioned above.

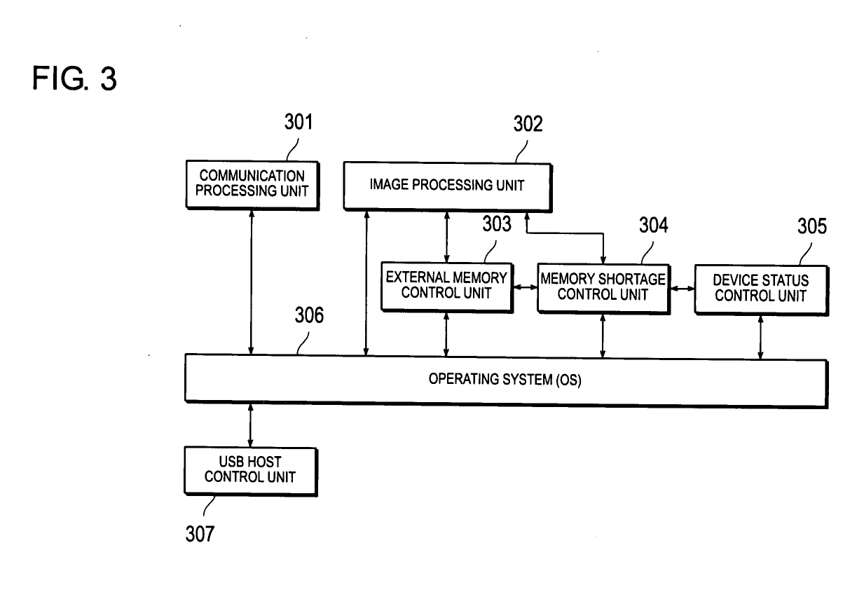

FIG. 3 is a diagram showing the constitution of a firmware mounted on the printer 100 of the present embodiment. The firmware includes a communication processing unit 301, an image processing unit 302, an external memory control unit 303, a memory shortage control unit 304, a device status control unit 305, an operating system (OS) 306, and a USB host control unit 307, and is stored in a memory unit such as the ROM 102.

The communication processing unit 301 conducts the communication process with a terminal device such as a PC (Personal Computer), and receives printing data from, for example, the PC. The image processing unit 302 conducts image processing by analyzing the printing data received via the communication processing unit 301. The external memory control unit 303 monitors the attaching and detaching of the external memory 250. The external memory control unit 303 registers to the operating system 306 a vacant space of the connected external memory as a virtual memory area and provides the virtual memory area that can be used for the image processing unit 302. When it is judged that a memory shortage status has arisen due to the lack of vacant areas in the internal memory, the memory shortage control unit 304 notifies the memory shortage status to the device status control unit 305. Also, the memory shortage control unit 304 requests the external memory control unit 303 to provide a usable virtual memory area in place of the decreased internal memory area. The device status control unit 305 controls the device's status. Moreover, the device status control unit 305 causes the operating panel 104 to display information such as error status or error averting procedure information. The operating system 306 is a basic system for controlling hardware resources including the memory and for causing upper level applications to function more efficiently. The USB host control unit 307 controls the hardware of the USB host controller at the external memory interface 107. The USB host control unit 307 is in charge of establishing the connection and disconnection with the external memory 250 as well as data read/write. The abovementioned functions of the firmware are realized by the CPU 101 executing the corresponding programs on the RAM 103.

The operation of the printer 100 in this embodiment will be described in the following.

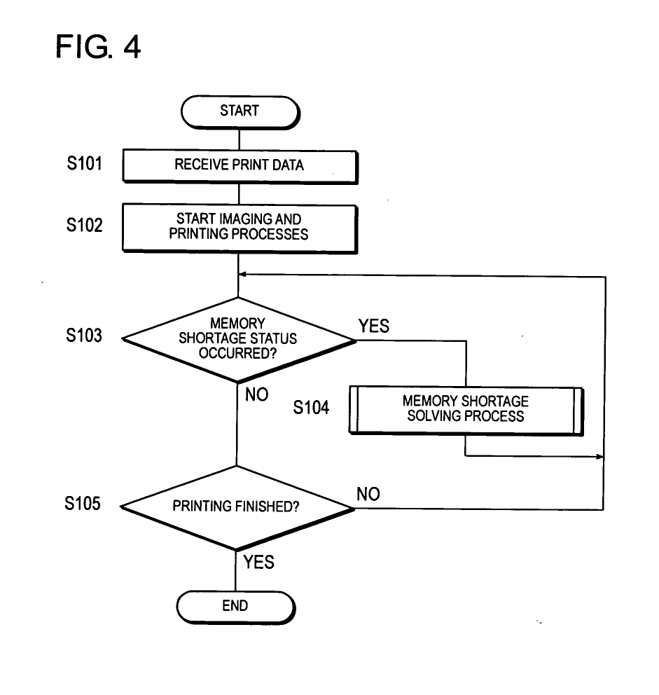

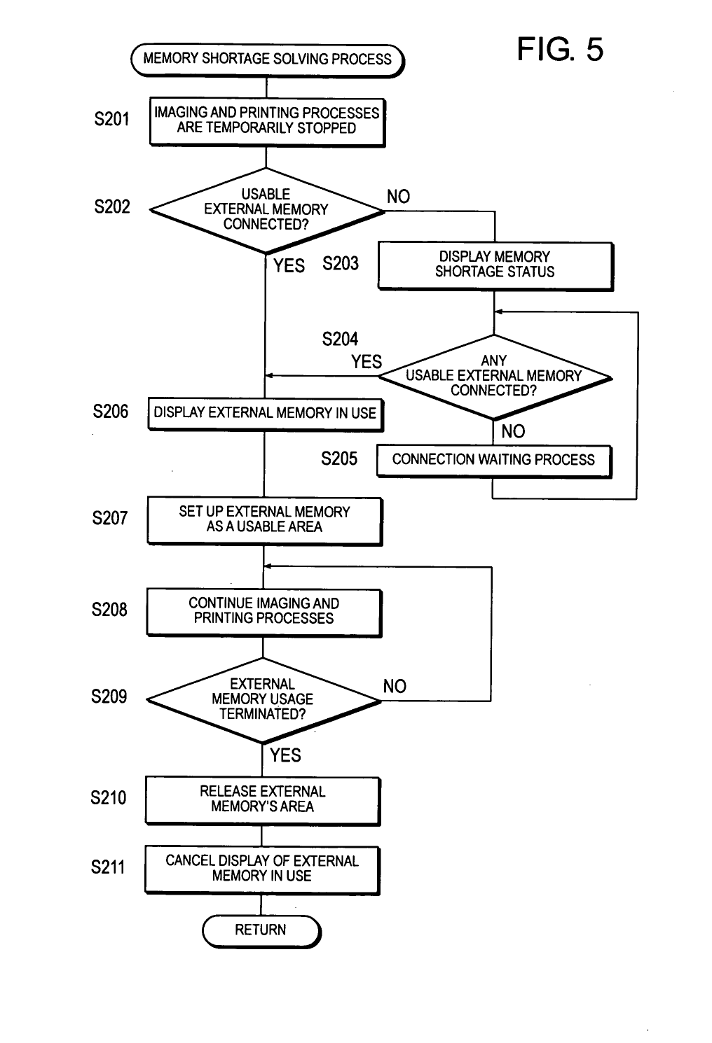

FIG. 4 and FIG. 5 are flowcharts showing the sequence of printing process by the printer 100 in the present embodiment.

The algorithm shown in the flowcharts of FIG. 4 and FIG. 5 is stored as a program in a memory unit such as a ROM 102 of the printer 100, read and executed on the RAM 103 by the CPU 101.

With reference to FIG. 4, the printer 100 receives printing data, for example, from a terminal device such as a PC via the network interface 106 (S101). However, the printing data can be entered by the user by instructions through the operating panel 104. Furthermore, if the printer 100 is such that it can directly process a file of a PDF (Portable Document Format), the PDF file as printing data can be provided from the external memory 250 via the external memory interface 107.

Next, the image process and the printing process start as a part of the image forming process based on the printing data (S102). In other words, the image processing unit 302 executes the imaging process by analyzing the received printing data. The printing data is described by a page description language and contains multiple types of data such as commands (procedures), font data and image data. More specifically, the image processing unit 302 prepares bitmap data, which will be printing output images, in a page unit or a band unit in accordance with a series of commands (procedures). The prepared bitmap data is transferred to the printing unit 105, where the printing process is conducted.

While the image processing is conducted, data that is not allowed to be erased as it is expected to be used continues to be accumulated in the internal memory, as the printing output is not yet completed. The image processing unit 302 uses the internal memory dividing its area depending on the purpose of each of the various types of printing data in order to use the internal memory efficiently. Various types of printing data include commands, font data, image data, display lists that are intermediate data prepared in the imaging process, bitmap data prepared in the imaging process, etc.

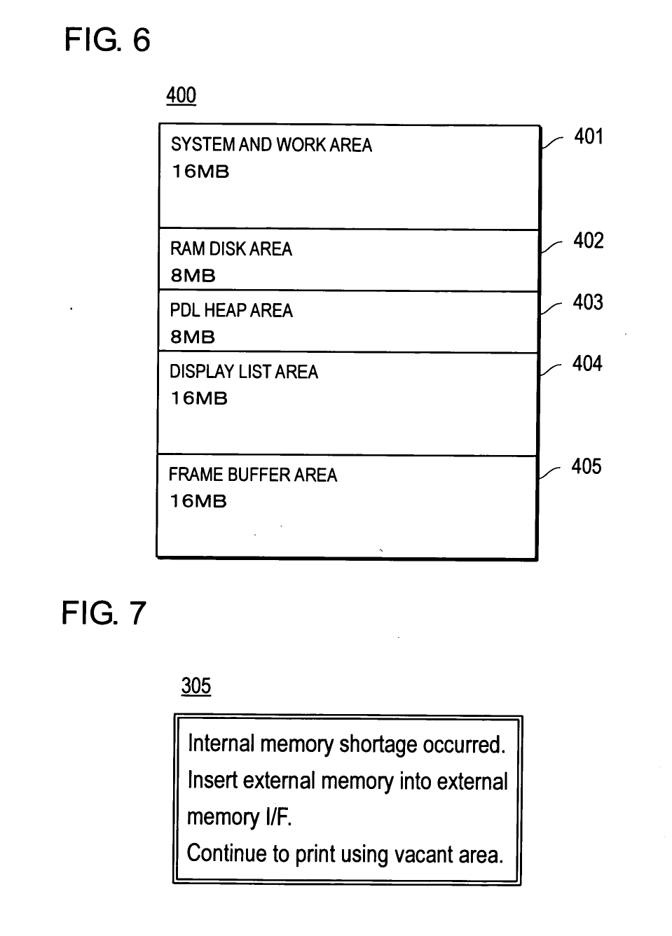

FIG. 6 is a diagram showing various areas of the internal memory each allocated to each type of printing data. As shown in FIG. 6, an area 400 of the internal memory includes a system and work area 401, a RAM disk area 402, a PDL HEAP area 403, a display list area 404, and a frame buffer area 405. The system and work area 401 stores commands and for example has a capacity of 16 MB. The RAM disk area 402 stores font data and for example has a capacity of 8 MB. The PDL HEAP area 403 stores image data and for example has a capacity of 8 MB. The display list area 404 stores display list and for example has a capacity of 16 MB. The frame buffer area 405 stores bitmap data and for example has a capacity of 16 MB.

In step S103, a judgment is made as to whether the memory area shortage status was generated or not regarding the shortage of the internal memory area.

Memory shortage status here can include a case where memory area shortage is expected in addition to a case where memory area shortage is actually detected. Future memory usage amount can be estimated from the usage status of each of areas 401-405 of the internal memory and the result of analysis of the received printing data. The result of an analysis may include, for example, either color printing or monochromatic printing, printing by departments, paper size, either text printing or image printing, etc.

The occurrence of memory shortage is preferably judged for each of the areas 401-405. Moreover, the usage limit for concluding that a memory shortage status has occurred is preferably set up for each of the areas 401-405. The usage limit can be expressed, for example, by the usage rate (e.g., 80%) for each of the areas 401-405 of the internal memory.

The usage limit can also be expressed in term of usable capacity (number of bytes). It is also possible to allocate the external memory always to processes related to printing data by setting the usage limit to zero.

The following is an example of a case in which a memory shortage status occurs. (1) Because the data size of the command in the received printing data is too large, there is a shortage of vacant area in the system and work area 401 of the internal memory, making the next command's analysis impossible, thus generating a memory shortage status. (2) Because the data size of the font data included in the received printing data is too large, there is a shortage of vacant area in the RAM disk area 402 of the internal memory, making the imaging process impossible to continue, thus generating a memory shortage status. (3) Because the data size of the image data included in the received printing data is too large, there is a shortage of vacant area in the PDL HEAP area 403 of the internal memory, making the imaging process impossible to continue, thus generating a memory shortage status. (4) As the data size of the display list prepared in the imaging process based on the received printing data has grown too large, there is a shortage of vacant area in the display list area 404, making the imaging process impossible to continue, thus generating a memory shortage status. (5) Because the data size of the bitmap data generated by the imaging process has grown too large, making the imaging process impossible to continue, thus generating a memory shortage status. (6) In a case where printing by departments is specified and also where the system accumulates printing data for all pages, a shortage of vacant area occurs in which the data such as bitmap data for all pages is to be accumulated, thus generating a memory shortage status.

If it is judged that no memory shortage status exists in step S103 (S103: No), the imaging process and the printing process continue to make a judgment as to whether the printing is completed or not (S105). When the printing is completed (S105: Yes), the process shown in FIG. 4 is completed. If the printing is not completed (S105: No), the program returns to step S103 to continue the imaging process and the printing process while monitoring if memory shortage has occurred.

On the other hand, if it is judged that memory shortage status has occurred in step S103 (S103: Yes), a memory shortage solving process is conducted (S104). At this time, the imaging process unit 302 notifies to the memory shortage control unit 304 that a memory shortage status has occurred when it is judged that the memory shortage status has occurred. Next, the memory shortage solving process is described with reference to FIG. 5.

First, the imaging process and the printing process are stopped temporarily (S201).

Next, a judgment is made as to whether the usable external memory 250 is connected to the printer 100 or not (S202).

If the external memory 250 is not connected to the printer 100 (S202: No), the information that notifies the occurrence of a memory shortage status is displayed on the display panel 205 of the operating panel 104 (S203). At this point, the memory shortage control unit 304 notifies the memory shortage status to the device status control unit 305, and the device status control unit 305 issues an instruction to display information on the display panel 205 to notify the occurrence of the memory shortage status.

FIG. 7 is a display example of information notifying a memory shortage status. As shown in FIG. 7, the notification of the memory shortage status occurrence preferably includes a message to prompt the external memory to be connected. Next, a judgment is made again in step S204 as to whether the usable external memory 250 is connected to the printer 100 or not. If it is judged that the usable external memory 250 is not connected to the printer 100 in step S204 (S204: No), a process of waiting the connection of the external memory 250 to the printer 100 by the user is executed (S205), and the program returns to the step S204. Moreover, if an instruction by the user is received in step S205 to cancel the printing process, the processes shown in FIG. 4 and FIG. 5 are terminated.

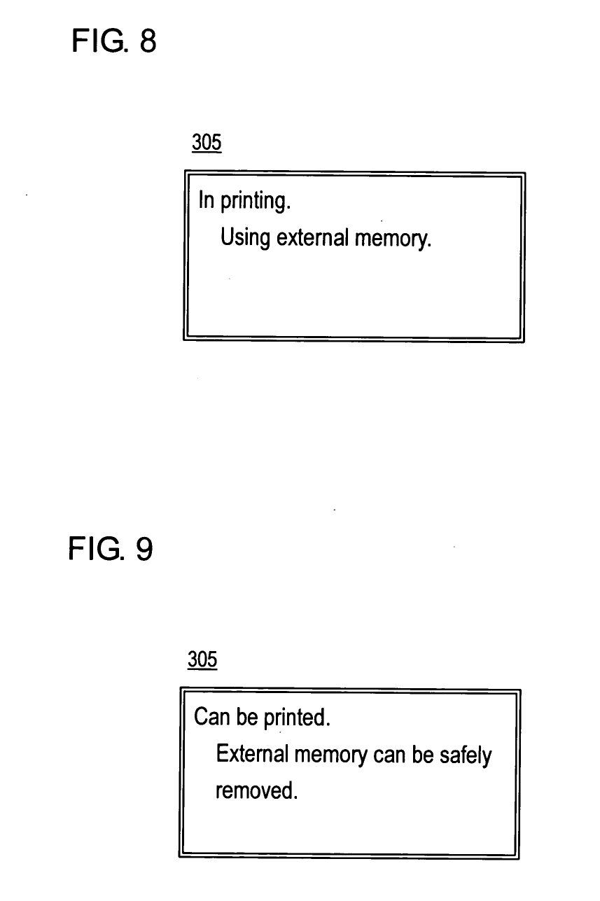

On the other hand, if it is judged that the external memory 250 is connected to the printer 100 in step S202 or S204 (S202: Yes, S204: Yes), information notifying that the external memory 250 is in use is displayed on the display panel 205 as shown in FIG. 8 (S206). The external memory status display lamp 204 turns into a flashing state.

If the external memory 250 is inserted into the connector 203 of the external memory interface 107 of the printer 100, the USB host control unit 307 detects said connection and registers the external memory 250, which is a memory device of the Mass Storage Class of the USB standard, as a file device on the file system via the operating system 306. By registering the external memory 250 as a file device, the operating system 306 becomes able to read and write the memory area in the external memory 250 as a file. The USB host control unit 307 notifies the external memory control unit 303 that the external memory 250 has become usable when the external memory 250 has become readable and writable.

Next, the external memory 250 is set up as a usable area in place of the internal memory area causing shortage (S207). At this point, the memory shortage control unit 304 requests the external memory control unit 303 to provide a usable virtual memory area in place of the decreased internal memory area. The external memory control unit 303 registers the vacant space of the external memory as a virtual memory area via the operating system 306. The virtual memory area is used in the same manner as the internal memory or for saving the internal memory's data.

Next, the imaging process and the printing process which have been temporarily stopped are restarted and continued (S208). The imaging process unit 302 can continue printing by avoiding the occurrence of the internal memory shortage using the virtual memory area.

In the step S209, a judgment is made as to whether the usage of the external memory 250 has been terminated or not. At this point, it is judged that the usage of the external memory 250 is terminated when the data inside the virtual memory area became unnecessary in the printing process or because of the printing output is completed, etc.

If it is judged that the usage of the external memory 250 is terminated (S209: Yes), the area of the external memory 250 is liberated. In other words, the unused state of the virtual memory is notified to the external memory control unit 303, and the external memory control unit 303 deletes the virtual memory area in the unused state.

Next, the information displayed on the display panel 205 notifying that the external memory 250 is in use is removed (S211).

At this time, the external memory control unit 303 notifies the unused status of the external memory 250 to the memory shortage control unit 304, and the memory shortage control unit 304 issues a notice that the unused memory 250 can be removed to the device status control unit 305. The device status control unit 305 issues an instruction to display on the display panel 205 information notifying that the external memory 250 can be removed. FIG. 9 is a display example of information notifying that the external memory 250 can be removed. At this point, the external memory status indicating lamp 204 switches from the flashing status to the continuously lighted status.

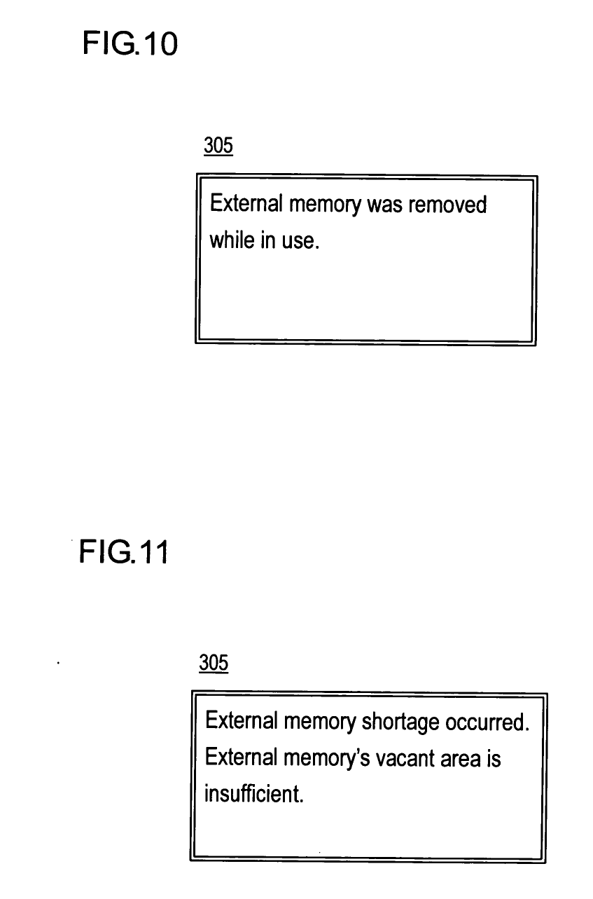

When the external memory 250 is removed while the virtual memory area is in use, or when the external memory 250 is short of vacant areas, the error status related to the external memory will be notified to the device status control unit 305. The device status control unit 305 issues an instruction to display on the display panel 205 information notifying that an error status concerning the external memory exists. FIG. 10 is a display example notifying the error status when the external memory 250 is removed while the virtual memory area is being used, and FIG. 11 is a display example of information to notify the error status when the printing cannot be continued due to the shortage of vacant area in the external memory 250. Various pieces of information displayed on the display panel 205 can be constituted by icons and/or messages.

The printer 100 of the present embodiment receives printing data and sets the area of the external memory 250 as the area that is usable for processing the received printing data when it is judged that memory shortage status is occurred concerning a shortage of vacant areas in the internal memory built into the printer 100 and when it is detected that the external memory 250 is connected to the external memory interface 107 that can be connected to or disconnected from the particular printer while the printer 100 is powered.

Therefore, if the internal memory's memory shortage status occurs, it becomes possible to continue the printing process using the external memory 250 for processing the printing data while the printer 100 is being energized (powered). Further, since it is unnecessary to increase the memory capacity or have the hard disk connected all the time, it is possible to avert the memory shortage problem with a relatively inexpensive constitution. Moreover, since it does not use an external device that is connected in advance to a printer 100 via a network, it is not necessary to make a complex control concerning the data transfer.

As can be seen from the above, the present embodiment provides a simple and quick solution for the memory shortage problem of the printer 100 and allows the printer to continue printing processes.

The invention is not limited to the embodiment described above, but also can be changed in various ways within the scope of the claims.

For example, although it was described in the abovementioned embodiment using a USB memory as the external memory 250, the invention is not limited to it. The external memory 250 means a storage medium with portability, which includes typically, in addition to USB memories, Compact Flash (registered trademark) memory, SD card memory, etc. The external memory 250 can also be any portable terminal device such as an information portable terminal and a cellular phone being equipped with a built-in or externally attached storage medium. The connection unit for allowing connecting or disconnecting the external memory 250 can be any interface that corresponds to said external memory.

Also, although the embodiments described above uses a printer as the image forming device, the invention is not limited to it. Various other image forming devices such as a copying machine and MFP (Multi-Function Peripheral) can be used as well in the present invention.

The means and method of conducting various processes in the image forming device according to the present invention can be realized by means of a dedicated hardware circuit, or a programmed computer. Said program can be provided either by a computer readable storage medium such as a flexible disk and a CD-ROM, or by being supplied on-line via a network such as the Internet. In this case, the program recorded on the computer readable storage medium is normally transferred to and stored in a memory unit such as a hard disk. Said program can also be provided as independent application software or can be built into the software of the image processing device as a part of its function.

What is claimed is:

1. An image forming device, comprising:
a receiving unit for receiving printing data;
a connection unit that is capable of connecting and disconnecting an external memory to and from said image forming device while the image forming device is powered; and
a control unit for setting at least a portion of said external memory's area as an area usable for processing data related to image forming based on said printing data when the external memory is connected to said connection unit.

2. The image forming device as claimed in claim 1, wherein
said control unit sets at least a portion of said external memory's area as an area usable for processing data related to said printing data when it is judged that a memory shortage status has occurred related to vacant space shortage in the internal memory built into said image forming device.

3. The image forming device as claimed in claim 2, wherein
said control unit issues a notification that memory shortage status has occurred when it is judged that said memory shortage status occurred and the external memory is not connected to said connection unit.

4. The image forming device as claimed in claim 3, wherein
said notification contains a message for prompting the connection of the external memory.

5. The image forming device as claimed in claim 1, wherein
said control unit issues a notification that the external memory can be disconnected if said external memory is connected to said connection unit and the use of said external memory is terminated from processing related to said printing data.

6. The image forming device as claimed in claim 2, wherein
the generation of said memory shortage status is judged for each area of said internal memory allocated for each of a plurality of types of data related to said printing data.

7. The image forming device as claimed in claim 6, wherein
said plurality of types of data are at least two of commands, font data, image data, intermediate data prepared in the imaging process, and bitmap data prepared after the imaging process.

8. An image forming method executed in an image forming device comprising:
1) receiving printing data; and
2) setting at least a portion of an external memory's area as an area usable for processing related to image forming based on said printing data when the external memory is connected to said connection unit that is capable of connecting and disconnecting an external memory to and from said image forming device while the image forming device is powered.

9. The image forming method as claimed in claim 8, wherein
in said step 2), at least a portion of said external memory's area is set as an area usable for processing related to said printing data when it is judged that a memory shortage status has occurred related to vacant space shortage in the internal memory built into said image forming device.

10. The image forming method as claimed in claim 9 further comprising:
3) notifying that memory shortage status has occurred when it is judged that said memory shortage status occurred and the external memory is not connected to said connection unit.

11. The image forming method as claimed in claim 10, wherein
said notification contains a message for prompting the connection of the external memory.

12. The image forming method as claimed in claim 8 further comprising:
4) issuing a notification that the external memory can be disconnected if said external memory is connected to said connection unit and the use of said external memory is terminated form processing related to said printing data.

13. The image forming method as claimed in claim 9, wherein
the generation of said memory shortage status is judged for each area of said internal memory allocated for each of a plurality of types of data related to said printing data.

14. The image forming method as claimed in claim 13, wherein
said plurality of types of data are at least two of commands, font data, image data, intermediate data prepared in the imaging process, and bitmap data prepared after the imaging process.

15. A computer readable storage medium storing an image forming program, said image forming program causing a computer to execute a process comprising:
1) receiving printing data; and
2) setting at least a portion of an external memory's area as an area usable for processing related to image forming based on said printing data when the external memory is connected to said connection unit that is capable of connecting and disconnecting an external memory to and from said image forming device while the image forming device is powered.

16. The computer readable storage medium as claimed in claim 15, wherein
said image forming program sets in said procedure 2) at least a portion of said external memory's area as an area usable for processing related to said printing data when it is judged that a memory shortage status has occurred related to vacant space shortage in the internal memory built into said image forming device.

17. The computer readable storage medium as claimed in claim 16, wherein
said image forming program further comprises:
3) notifying that memory shortage status has occurred when it is judged that said memory shortage status occurred and the external memory is not connected to said connection unit.

18. The computer readable storage medium as claimed in claim 17, wherein
said notification contains a message for prompting the connection of the external memory.

19. The computer readable storage medium as claimed in claim 15, wherein
said image forming program further comprises:
4) notifying that the external memory can be disconnected if said external memory is connected to said connection unit and the use of said external memory is terminated from processing related to said printing data.

20. The computer readable storage medium as claimed in claim 16, wherein
the generation of said memory shortage status is judged for each area of said internal memory allocated for each of a plurality of types of data related to said printing data.

21. The computer readable storage medium as claimed in claim 20, wherein
said plurality of types of data are at least two of commands, font data, image data, intermediate data prepared in the imaging process, and bitmap data prepared after the imaging process.
